(19) United States
(12) Patent Application Publication
(10) Pub. No.: US 2014/0144413 A1
(43) Pub. Date: May 29, 2014

(54) Engine Including Exhaust Gas Recirculation Injection System

(71) Applicant: GM GLOBAL TECHNOLOGY OPERATIONS LLC, Detroit, MI (US)

(72) Inventors: Ronald J. PIERIK, Holly, MI (US); Jeffrey David ROHE, Cutler, IN (US); Craig GARVIN, Cambridge, MA (US)

(73) Assignee: GM GLOBAL TECHNOLOGY OPERATIONS LLC, Detroit, MI (US)

(21) Appl. No.: 13/688,847

(22) Filed: Nov. 29, 2012

(51) Int. Cl. F02M 25/07; F02B 47/08

(52) U.S. Cl. CPC F02M 25/077; F02B 47/08
USPC 123/568.12; 123/568.13

(57) ABSTRACT

An engine assembly according to the principles of the present disclosure includes an engine structure, an intake system, an exhaust system, and an exhaust gas recirculation (EGR) assembly. The engine structure defines cylinders having intake and exhaust ports. The intake system includes an intake manifold that provides air to the cylinders through the intake ports. The exhaust system includes an exhaust manifold in communication with the exhaust ports for expelling exhaust gas from the cylinders. The EGR system includes an EGR pipe, an EGR valve, an EGR reservoir, and an EGR injector. The EGR pipe extends from at least one of the exhaust system, the exhaust ports, and the cylinders to the EGR reservoir. The EGR valve regulates exhaust flow through the EGR pipe. The EGR injector is operable to deliver exhaust gas from the EGR reservoir directly to at least one of the intake ports and the cylinders.

### FIELD

The present disclosure relates to internal combustion engines, and more specifically, to engines including an exhaust gas recirculation system.

### BACKGROUND

This section provides background information related to the present disclosure which is not necessarily prior art.

An exhaust gas recirculation (EGR) system typically includes a single EGR valve disposed between an exhaust system of an engine and an intake manifold of the engine. The EGR valve may be opened to introduce exhaust gas into the intake manifold. The location in the intake manifold where exhaust gas is introduced may be selected to distribute an equal amount of exhaust gas to each cylinder in the engine. However, during transient conditions such as transitions from idle to wide open throttle, variations in engine speed and load and the resulting changes in intake airflow may cause an unequal amount of exhaust gas distribution to each cylinder.

Unequal distribution of exhaust gas to cylinders of the engine may cause a misfire in a cylinder due to an excessive amount of exhaust gas in the cylinder. To avoid this, the amount of exhaust gas introduced into the intake manifold may be restricted relative to a maximum amount of exhaust gas that can be provided to each cylinder without causing misfire. Providing less than the maximum amount of exhaust gas to each cylinder results in a fuel economy loss.

In addition, during transient conditions, desired amounts of air, fuel, and exhaust gas provided to cylinders of an engine rapidly change. Thus, the amount of exhaust gas within an intake manifold of the engine must also rapidly change to provide the desired amount of exhaust gas to the cylinders. However, the volume of an intake manifold is typically up to 50 percent greater than engine displacement. Thus, several engine cycles are required to purge all exhaust gas from an intake manifold and achieve a desired amount of exhaust gas in the intake manifold corresponding to a new engine operating condition.

Accordingly, there is a need for an EGR system that distributes an equal amount of exhaust gas to each cylinder of an engine. In addition, there is a need for an EGR system that responds rapidly to provide a desired amount of exhaust gas to each cylinder of an engine during transient conditions.

### SUMMARY

This section provides a general summary of the disclosure, and is not a comprehensive disclosure of its full scope or all of its features.

An engine assembly according to the principles of the present disclosure includes an engine structure, an intake system, an exhaust system, and an exhaust gas recirculation (EGR) assembly. The engine structure defines cylinders having intake and exhaust ports. The intake system includes an intake manifold that provides air to the cylinders through the intake ports. The exhaust system includes an exhaust manifold in communication with the exhaust ports for expelling exhaust gas from the cylinders. The EGR system includes an EGR pipe, an EGR valve, an EGR reservoir, and an EGR injector. The EGR pipe extends from at least one of the exhaust system, the exhaust ports, and the cylinders to the EGR reservoir. The EGR valve regulates exhaust flow through the EGR pipe. The EGR injector is operable to deliver exhaust gas from the EGR reservoir directly to at least one of the intake ports and the cylinders.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an engine assembly according to the present disclosure;

FIG. 2 is a fragmentary section view of an engine structure included in the engine assembly shown in FIG. 1;

FIG. 3 is a graph illustrating opening of an exhaust gas recirculation (EGR) injector according to the present disclosure; and

FIG. 4 is a schematic illustration of an alternative embodiment of an engine assembly according to the present disclosure.

Corresponding reference numerals indicate corresponding parts throughout the several views of the drawings.

### DETAILED DESCRIPTION

Example embodiments will now be described more fully with reference to the accompanying drawings.

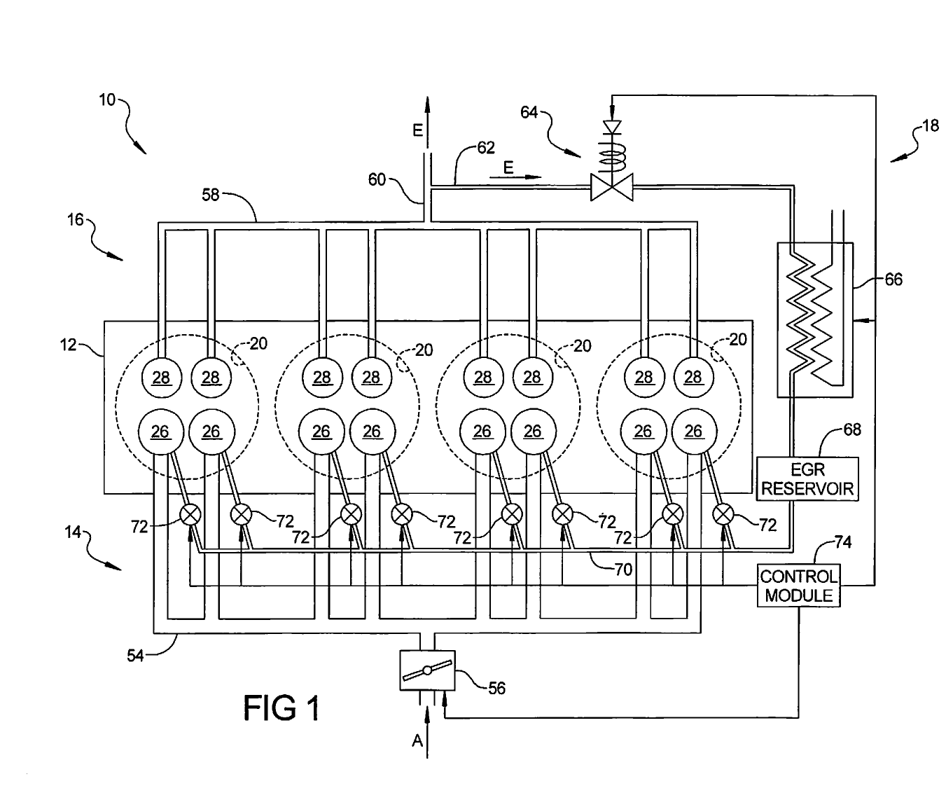

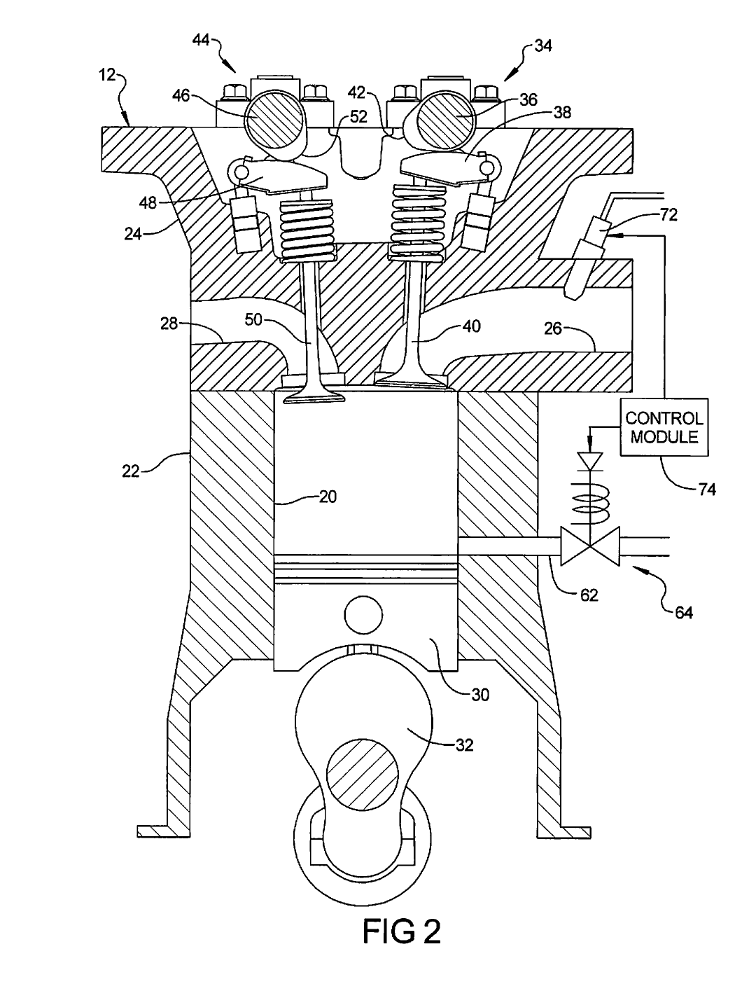

With reference to FIGS. 1 and 2, an engine assembly 10 includes an engine structure 12, an intake system 14, an exhaust system 16, and an exhaust gas recirculation (EGR) assembly 18. The engine structure 12 defines cylinder bores 20 forming cylinders. As shown in FIG. 2, the engine structure 12 includes an engine block 22 defining the cylinder bores 20 and a cylinder head 24 coupled to the engine block 22 and defining intake and exhaust ports 26, 28 in communication with the cylinders. Intake air from the intake system 14 enters the cylinders through the intake ports 26, and exhaust gas is expelled from the cylinders to the exhaust system 16 through the exhaust ports 28. A piston 30 is disposed within the cylinder bore 20 and coupled to a crankshaft 32. Reciprocation of the piston 30 causes rotation of the crankshaft 32, which provides drive torque for a vehicle.

An intake valvetrain 34 is coupled to the cylinder head 24 and regulates the flow of intake air through the intake ports 26. The intake valvetrain 34 includes an intake camshaft 36, rocker arms 38, and intake valves 40. The intake camshaft 36 is coupled to the crankshaft 32 for rotation therewith. As the intake camshaft 36 rotates, lobes 42 on the intake camshaft 36 engage the rocker arms 38, causing the rocker arms 38 to pivot in a direction that opens the intake valves 40. The timing, lift, and/or duration of intake valve openings may be adjusted using intake cam phasers.

An exhaust valvetrain 44 is coupled to the cylinder head 24 and regulates the flow of exhaust gas through the exhaust ports 28. The exhaust valvetrain 44 includes an exhaust camshaft 46, rocker arms 48, and exhaust valves 50. The exhaust camshaft 46 is coupled to the crankshaft 32 for rotation therewith. As the exhaust camshaft 46 rotates, lobes 52 on the exhaust camshaft 46 engage the rocker arms 48, causing the rocker arms 48 to pivot in a direction that opens the exhaust valves 50. The timing, lift, and/or duration of exhaust valve openings may be adjusted using exhaust cam phasers.

An inline engine configuration having four cylinders is schematically shown in FIG. 1 for illustration purposes only. It is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

As shown in FIG. 1, the intake system 14 includes an intake manifold 54 and a throttle valve 56. The intake manifold 54 is coupled to the engine structure 12 and is in communication with the cylinders. The throttle valve 56 is in communication with the intake manifold 54 and controls air flow (A) to the intake manifold 54. The exhaust system 16 includes an exhaust manifold 58 and an exhaust pipe 60. The exhaust manifold 58 is coupled to the engine structure 12 and is in communication with the cylinders. The exhaust pipe 60 extends from the exhaust manifold 58 and is in communication with the cylinders for routing exhaust flow (E) therefrom.

The EGR assembly 18 recirculates some of the exhaust flow (E) to the cylinders and includes an EGR pipe 62, an EGR valve 64, a heat exchanger and dehumidifier 66, an EGR reservoir 68, an EGR rail 70, and EGR injectors 72. The EGR pipe 62 may extend from the exhaust system 16, such as from the exhaust pipe 60 as shown in FIG. 1. Alternatively, the EGR pipe 62 may extend from the exhaust ports 28 and/or directly from the cylinders, such as from near the bottom of the cylinder bores 20 as shown in FIG. 2. The EGR pipe 62 extends to the EGR reservoir 68 to provide exhaust gas thereto.

FIG. 1 shows the EGR pipe 62 extending from a single location on the exhaust pipe 60. Alternatively, the EGR pipe 62 may extend from multiple locations on the exhaust pipe 60. For example, the EGR pipe 62 may be in communication with a hot zone of the exhaust pipe 60 upstream from a catalytic converter and a cold zone of the exhaust pipe 60 downstream from the catalytic converter. In addition, multiple control valves may be used to control the amount of exhaust gas recirculated from each zone and thereby control the temperature of recirculated exhaust gas provided to the cylinders.

The EGR valve 64 is disposed in the EGR pipe 62 and regulates the flow of recirculated exhaust gas therethrough. The EGR valve 64 is schematically shown as a control valve such as a solenoid valve. Alternatively, the EGR valve 64 may be a check valve that allows flow in one direction from the exhaust system 16 to the EGR reservoir 68 and prevents flow in the opposite direction from the EGR reservoir 68 to the exhaust system 16.

The heat exchanger and dehumidifier 66 is disposed along the EGR pipe 62 and heats, cools, and/or regulates the humidity of recirculated exhaust gas. The heat exchanger and dehumidifier 66 may heat recirculated exhaust gas during a cold start. The heat exchanger and dehumidifier 66 may cool recirculated exhaust gas when the engine assembly 10 is operating at high load. The heat exchanger and dehumidifier 66 may reduce the relatively high humidity of recirculated exhaust gas during a cold start to decrease the amount of time required to warm up the engine assembly 10 and/or to prevent ice formation during cold operation. In normal operating conditions, the heat exchanger and dehumidifier 66 may maintain recirculated exhausted gas at a relatively high humidity level to absorb heat generated during combustion.

The EGR reservoir 68 stores recirculated exhaust gas. The EGR rail 70 extends from the EGR reservoir 68 to the EGR injectors 72 and provides communication therebetween. The EGR injectors 72 are coupled to the EGR rail 70 and the engine structure 12 and are in communication with the EGR reservoir 68 and the cylinders. The EGR injectors 72 may be opened to allow exhaust gas to flow from the EGR reservoir 68 to the cylinders.

As presently shown, the EGR injectors 72 inject exhaust gas into the intake ports 26. Alternatively, the EGR injectors 72 may inject exhaust gas directly into the cylinders, such as at the interface between the cylinders and the cylinder head 24 or lower in the cylinders. In various implementations, the EGR injectors 72 may be disposed at a location that is remote from the engine structure 12, and lines or runners may be routed from the EGR injectors 72 to the intake ports 26 or the cylinders.

As presently shown, one of the EGR injectors 72 is disposed at each of the intake ports 26. Alternatively, the EGR injectors 72 may be disposed at only one of the intake ports 26 for each cylinder. Thus, the four-cylinder arrangement illustrated may include only four of the EGR injectors 72 instead of eight of the EGR injectors 72 as shown. In various implementations, the EGR injectors 72 may be in communication with more than one cylinder and/or may be disposed at a remote location. For example, one of the EGR injectors 72 may be in communication with all of the cylinders and the others of the EGR injectors 72 may be omitted.

A control module 74 controls the throttle valve 56, the EGR valve 64, the heat exchanger and dehumidifier 66, and the EGR injectors 72. The control module 74 may control the EGR valve 64, the heat exchanger and dehumidifier 66, and the EGR injectors 72 to adjust the pressure, temperature, and/or humidity of exhaust gas stored in the EGR reservoir 68. In addition, the control module 74 may control the EGR injectors 72 to adjust the timing and/duration of openings of the EGR injectors 72.

The control module 74 may control the EGR valve 64 to allow flow in one direction from the exhaust system 16 to the EGR reservoir 68 and prevent flow in the opposite direction from the EGR reservoir 68 to the exhaust system 16. The control module 74 may open the EGR valve 64 to allow flow from the exhaust system 16 to the EGR reservoir 68 when the pressure of the EGR reservoir 68 is greater than the pressure in the exhaust system 16. The control module 74 may close the EGR valve 64 to prevent flow from the EGR reservoir 68 to the exhaust system 16 when the pressure of the EGR reservoir 68 is more than or equal to the pressure in the exhaust system 16.

The control module 74 may control the EGR valve 64 to increase the pressure of the EGR reservoir 68. If the EGR pipe 62 extends from the exhaust pipe 60, the control module 74 may synchronize opening of the EGR valve 64 with pressure pulses of exhaust flow through the exhaust pipe 60. If the EGR pipe 62 extends from the exhaust ports 28 or directly from the cylinders, the control module 74 may use cylinder pressure to increase the pressure of the EGR reservoir 68. In either case, the EGR assembly 18 may not require an EGR pump to pressurize exhaust gas within the EGR reservoir 68.

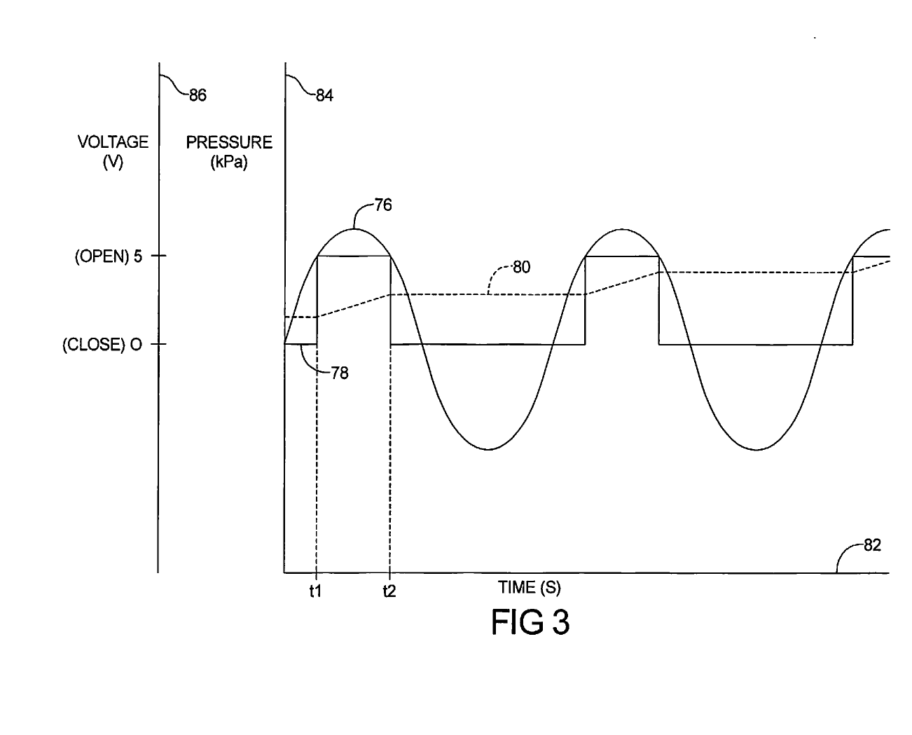

With reference to FIG. 3, the control module 74 may receive an exhaust pressure signal 76 and adjust a valve control signal 78 based thereon to adjust a reservoir pressure signal 80 to a desired level. The exhaust pressure signal 76 represents pressure in the exhaust pipe 60. The valve control signal 78 represents a voltage signal that is used to control the EGR valve 64. The reservoir pressure signal 80 represents pressure in the EGR reservoir 68. The exhaust pressure signal 76 and the reservoir pressure signal 80 are plotted with respect to an x-axis 82 that represents time in seconds and a y-axis 84 that represents pressure in kilopascals (kPa). The valve control signal 78 is plotted with respect to the x-axis 82 and a y-axis 86 that represents voltage in volts (V). In the example shown, the EGR valve 64 closes when the valve control signal 78 is 0 V and the EGR valve 64 opens when the valve control signal 78 is 5 V.

The control module 74 may adjust the valve control signal 78 to synchronize EGR valve openings with exhaust pressure pulses by opening the EGR valve 64 during periods that correspond to peaks in the exhaust pressure signal 76. In one example, the valve control signal 78 is adjusted to open the EGR valve 64 at a time t1 when the exhaust pressure signal 76 is approaching a peak. The EGR valve 64 is held open until after the exhaust pressure signal 76 reaches the peak. Since the period between the times t1 and t2 corresponds to a peak in the valve control signal 78, the reservoir pressure signal 80 increases during this period. In the example shown, the EGR injectors 72 are not opened to allow exhaust flow out of the EGR reservoir 68. Thus, the reservoir pressure signal 80 steadily increases with each opening of the EGR valve 64, until the EGR reservoir 68 pressure reaches that of the exhaust signal peaks 76, if desired by the control module 74.

Referring again to FIG. 1, the control module 74 may control the EGR injectors 72 to adjust the amount of exhaust gas provided to the cylinders and/or to control when the exhaust gas is provided. The control module 74 may adjust the duration for which the EGR injectors 72 are opened to adjust the amount of exhaust gas provided to the cylinders. Additionally or alternatively, the control module 74 may adjust the pressure of the EGR reservoir 68 to adjust the amount of exhaust gas provided. The control module 74 may control when the EGR injectors 72 are opened to adjust when the exhaust gas is provided to the cylinders.

The control module 74 may adjust the timing, duration, and/or location of EGR injections to yield different types of combustion in different cylinders during the same engine cycle. For example, some of the EGR injectors 72 may be controlled to yield homogeneous charge compression ignition (HCCI), while others of the EGR injectors 72 may be controlled to yield spark ignition (SI). The combustion types may be varied in this manner during transient conditions.

The control module 74 may adjust the timing and location of EGR injections to adjust mixture homogeneity and mixture motion, respectively, which affect the combustion type. Exhaust gas may be provided to the cylinders relatively early to concentrate recirculated exhaust gas near the top of the cylinders. Exhaust gas may be provided to the cylinders relatively late to concentrate recirculated exhaust gas near the bottom of the cylinders. Exhaust gas may be injected in only one of the intake ports 26 for each cylinder to yield a swirl effect within the cylinders.

The EGR assembly 18 delivers recirculated exhaust gas directly to the cylinders instead of delivering recirculated exhaust gas to the cylinders through the intake manifold 54. Thus, the EGR assembly 18 may distribute an equal amount of exhaust gas to each of the cylinders while avoiding delays associated with filling or purging the intake manifold 54. In turn, the overall amount of exhaust gas distributed to all of the cylinders may be increased since misfire as a result of unequal distribution of exhaust gas to the cylinders is less likely. Distributing more exhaust gas to the cylinders may improve fuel economy.

In addition, the pressure within the EGR reservoir 68 may be controlled as described above to yield high EGR flow rates relative to conventional EGR assemblies, which allows shorter EGR injection durations. In turn, the timing of the EGR injections may be precisely controlled to control the type of combustion in each of the cylinders as described above. High EGR flow rates, short EGR injection durations, and/or variable combustion types may be used to achieve a short response time relative to convention EGR assemblies, which may be particularly useful in transient conditions.

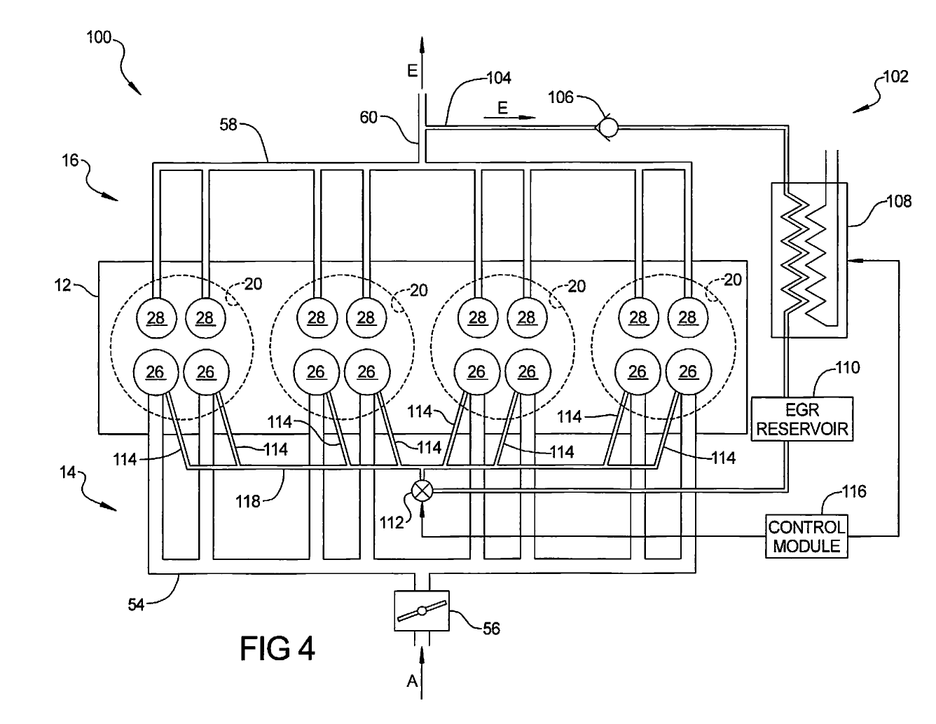

With reference to FIG. 4, an engine assembly 100 includes the engine structure 12, the intake system 14, and the exhaust system 16 included in the engine assembly 10 described above with referent to FIG. 1. However, the engine assembly 100 includes an EGR assembly 102 in place of the EGR assembly 18. The EGR assembly 102 includes an EGR pipe 104, an EGR valve 106, the heat exchanger 108, the EGR reservoir 110, an EGR injector 112, and a plurality of EGR runners 114.

The EGR pipe 104 may extend from the exhaust pipe 60 to the EGR injector 112 as shown. Alternatively, the EGR pipe 104 may extend from another location in the exhaust system 16, such as from the exhaust manifold 58, or the EGR pipe 104 may extend directly from the cylinders. The EGR valve 106 and the EGR reservoir 68 may be disposed in the EGR pipe 104, and the heat exchanger 108 may be disposed along the EGR pipe 104. The heat exchanger 108 and the EGR reservoir 110 may be structurally and functionally similar to the heat exchanger and dehumidifier 66 and the EGR reservoir 68 of FIG. 1.

The EGR valve 106 regulates the flow of exhaust gas through the EGR pipe 104. The EGR valve 106 is schematically shown as a check valve. Thus, the EGR valve 106 allows flow in one direction from the exhaust system 16 to the EGR reservoir 110 and prevents flow in the opposite direction from the EGR reservoir 110 to the exhaust system 16. Alternatively, the EGR valve 106 may be a control valve, such as a solenoid valve, that opens and closes based on a valve control signal received from a control module 116.

The EGR injector 112 is coupled to the engine structure 12 and is in communication with the EGR reservoir 110 and the cylinders. The EGR injector 112 may be opened to allow exhaust gas to flow from the EGR reservoir 68 to the cylinders. The control module 116 may open the EGR injector 112 to allow exhaust gas to flow from the EGR reservoir 110 to the intake ports 26. Distributing recirculated exhaust gas to multiple cylinders using a single EGR injector in this way reduces the cost and complexity associated with having an EGR injector for each cylinder or for each intake port.

As presently shown, the EGR injector 112 is disposed at a location that is remote from the engine structure 12 and injects exhaust gas into each of the intake ports 26 through the EGR runners 114. In various implementations, the EGR injector 112 may be mounted to the engine structure 12 while still delivering exhaust gas to the intake ports 26 through the EGR runners 114. Additionally, the EGR injector 112 may inject exhaust gas directly into the cylinders instead of or in addition to injecting exhaust gas into the intake ports 26.

In the example shown, the EGR runners 114 are connected to the EGR injector 112 using an EGR rail 118. The EGR runners 114 and/or the EGR rail 118 may include one or more devices, such as check valves, which prevent exhaust flow from one cylinder to another cylinder. Although the EGR runners 114 are shown connected to the EGR injector 112 using the EGR rail 118, the EGR runners 114 may be directly connected to the EGR injector 112. In either case, recirculated exhaust gas is delivered directly to the cylinders instead of delivering recirculated exhaust gas to the cylinders through the intake manifold 54. Thus, the EGR assembly 102 may be more capable of equally distributing exhaust gas to cylinders relative to conventional EGR assemblies.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As used herein, the term module may refer to, be part of, or include an Application Specific Integrated Circuit (ASIC); a discrete circuit; an integrated circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

What is claimed is:

1. An engine assembly comprising:
an engine structure defining cylinders having intake and exhaust ports;
an intake system including an intake manifold that provides air to the cylinders through the intake ports;
an exhaust system including an exhaust manifold in communication with the exhaust ports for expelling exhaust gas from the cylinders; and
an exhaust gas recirculation (EGR) assembly including an EGR pipe, an EGR valve, an EGR reservoir, and an EGR injector, the EGR pipe extending from at least one of the exhaust system, the exhaust ports, and the cylinders to the EGR reservoir, the EGR valve regulating exhaust flow through the EGR pipe, the EGR injector being operable to deliver exhaust gas from the EGR reservoir directly to at least one of the intake ports and the cylinders.

2. The engine assembly of claim 1 wherein the EGR valve includes a control valve.

3. The engine assembly of claim 1 wherein the EGR valve includes a check valve.

4. The engine assembly of claim 1 further comprising a heat exchanger disposed along the EGR pipe that is operable to at least one of heat, cool, and adjust a humidity level of exhaust gas flowing through the EGR pipe.

5. The engine assembly of claim 1 wherein the EGR pipe extends from the exhaust system.

6. The engine assembly of claim 1 wherein the EGR injector includes a plurality of EGR injectors mounted to the engine structure and in communication with one of the cylinders.

7. The engine assembly of claim 6 wherein each of the cylinders includes multiple intake ports and each of the EGR injectors is in communication with at least one of the intake ports.

8. The engine assembly of claim 6 further comprising an EGR rail that distributes exhaust gas from the EGR reservoir to each of the EGR injectors.

9. The engine assembly of claim 1 wherein the EGR injector is located remote from the engine structure and the EGR injector delivers exhaust gas to more than one of the cylinders through EGR runners.

10. The engine assembly of claim 1 further comprising a control module that controls at least one of the EGR valve and the EGR injector.

11. The engine assembly of claim 10 wherein the EGR pipe extends from the exhaust system and the control module opens the EGR valve during peaks in pressure pulses of exhaust gas flowing through the exhaust system.

12. The engine assembly of claim 10 wherein the control module adjusts at least one of EGR injection timing and EGR injection location to yield different types of combustion within the cylinders during a single engine cycle.

13. An exhaust gas recirculation (EGR) assembly for an engine assembly including an engine structure defining cylinders having intake and exhaust ports, an intake system including an intake manifold that provides air to the cylinders through the intake ports, and an exhaust system including an exhaust manifold in communication with the exhaust ports for expelling exhaust gas from the cylinders, the EGR assembly comprising:
an EGR reservoir;
an EGR pipe configured to extend from at least one of the exhaust system, the exhaust ports, and the cylinders to the EGR reservoir;
an EGR valve that regulates exhaust flow through the EGR pipe; and
an EGR injector that is operable to deliver exhaust gas from the EGR reservoir directly to at least one of the intake ports and the cylinders.

14. The engine assembly of claim 13 wherein the EGR valve includes a control valve.

15. The engine assembly of claim 13 wherein the EGR valve includes a check valve.

16. The engine assembly of claim 13 wherein the EGR injector includes a plurality of EGR injectors.

17. An engine assembly comprising:
an engine structure defining cylinders having intake and exhaust ports;
an intake system including an intake manifold that provides air to the cylinders through the intake ports;
an exhaust system including an exhaust manifold in communication with the exhaust ports for expelling exhaust gas from the cylinders; and
an exhaust gas recirculation (EGR) assembly including an EGR pipe, an EGR valve, an EGR reservoir, and an EGR injector, the EGR pipe extending from the exhaust system to the EGR reservoir, the EGR valve regulating exhaust flow through the EGR pipe, the EGR injector being operable to deliver exhaust gas from the EGR reservoir directly to the intake ports.

18. The engine assembly of claim 17 wherein the EGR injector includes a plurality of EGR injectors in communication with the intake ports.

19. The engine assembly of claim 17 further comprising an EGR rail that provides communication between the EGR reservoir and the EGR injectors.

20. The engine assembly of claim 17 further comprising a heat exchanger disposed along the EGR pipe that is operable to at least one of heat, cool, and adjust a humidity level of exhaust gas flowing through the EGR pipe.
